(19) United States
(12) Patent Application Publication
(10) Pub. No.: US 2026/0181103 A1
(43) Pub. Date: Jun. 25, 2026

(54) SWIPE-TO-MATCH VIDEO CHAT SYSTEM AND METHOD WITH INFINITE SCROLL AND REAL-TIME PARTICIPANT TRANSITION

(71) Applicant: Callan Goldeneye, Mesa, AZ (US)

(72) Inventor: Callan Goldeneye, Mesa, AZ (US)

(21) Appl. No.: 19/001,245

(22) Filed: Dec. 24, 2024

(51) Int. Cl. H04N 7/14; G06F 3/04883

(52) U.S. Cl. CPC H04N 7/147; G06F 3/04883

(57) ABSTRACT

System and method facilitating real-time communication between users through an online chat interface. An application allows users to create an account and interact through a touch screen user interface. A real-time list of online users is created, and a primary user live chats with a selected chat partner displayed in a chat window. The user interface allows the primary user to select a new chat partner by swiping on the interface. Video quality may be adjusted using an adaptive bandwidth management system, providing a tactile response when the user interacts with the interface, implementing a multi-layered security protocol for safe data transmission, and running a load forecasting algorithm to predict user activity. A dummy version of the new chat partner is created and presented to the primary user before establishing a live chat.

### FIELD OF THE INVENTION

The present disclosure relates to gesture-based navigation systems, particularly those implemented on random chat platforms. The technology focuses on enhancing user interactions through swipe gesture methodologies, infinite scroll interfaces, and session-based tracking mechanisms to optimize ergonomics and efficiency in mobile device interfaces.

### BACKGROUND OF THE INVENTION

In the field of user interface design for digital interaction systems, particularly in random chat platforms, the prevailing methods often rely on button-based navigation for transitioning between chat partners. These systems typically involve distinct button presses to move forward or backward through chat sessions, which can lead to disruptive user experiences on mobile devices where ergonomic and fluid interactions are increasingly prioritized. The reliance on button-based navigation presents challenges in maintaining continuous engagement, as users may encounter transitional gaps or interruptions, limiting the seamlessness of the interaction.

Existing technologies in this domain tend to suffer from limitations that include latency during navigation and a lack of customizable interaction options. Such systems may not preload user connections dynamically, resulting in delays that disrupt the flow of conversation when engaging with different chat partners. Additionally, traditional implementations often require persistent server-side data storage for session history, creating potential user privacy concerns and increased storage demands. These established methods fail to adequately address the need for a fluid, uninterrupted user experience that can accommodate the dynamic nature of random chat interactions.

Moreover, conventional interfaces rarely provide feedback mechanisms that enhance the perception of responsiveness necessary for contemporary user interface expectations. Visual or haptic feedback to indicate successful transitions between chat partners is often missing, reducing the overall responsiveness perceived by the user. The lack of flexibility in navigation methods, such as alternative gesture controls or sensitivity adjustments, further constrains user accessibility and personalization, key factors in designing modern, adaptive interfaces.

What is needed is a system that introduces continuous gesture-based navigation to replace conventional button-based mechanics, thereby offering an ergonomic, efficient, and fluid user interface experience. Such a system would incorporate dynamic loading capabilities to mitigate latency issues and support session-based tracking to enhance privacy while reducing server-side data storage. Additionally, providing customizable gesture controls and responsive feedback mechanisms would cater to varying user needs and preferences, ultimately enhancing the user experience across diverse digital platforms.

### SUMMARY OF THE INVENTION

The present invention generally relates to facilitating real-time communication between users through an online chat interface. The method includes providing an application that allows multiple users to create a user account and interact in the application through a touch screen user interface. The application creates a real-time list of online users and allows a primary user to live chat with a chat partner selected from the list of online users.

The user interface is configured to allow the primary user to select a new chat partner by swiping on the user interface. In some embodiments, the client interacts with the server through WebSockets. The method may further include adjusting the video quality of the primary user and the chat partner using an adaptive bandwidth management system. The method may also provide a tactile response when the user takes an action through the user interface. In some embodiments, a multi-layered security protocol is implemented to ensure the safe transmission of user data during a video chat. The method may also include running a load forecasting algorithm to predict peaks in user activity.

In some embodiments, a dummy version of the new chat partner is created and presented to the primary user before the live chat is established with the new chat partner. The dummy version may be optimized to reduce perceived latency for the primary user. In some embodiments, the dummy version is a chat window without the new chat partner displayed in the chat window.

The invention also includes a system for facilitating instantaneous video chats between a user and a chat partner. The system includes a user interface configured to simulate infinite scrolling between video chat participants by dynamically loading new participants in real-time. A dummy component is instantiated initially as a placeholder without a live video feed. A WebSocket protocol implementation is used to establish a full-duplex, persistent connection between a client and a server for real-time data exchange. The backend architecture is adapted to support high concurrency utilizing load-balancing techniques. The user interface tracks finger movements of the user to provide fluid transitions between video chat participants.

In some embodiments, the backend architecture includes an Elixir programming framework to optimize real-time video chat functionality. The dummy component creates a continuous interface illusion during the transition to a live participant.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 depicts an initial user interface for an infinite scroll chat interface of one or more embodiments of the invention;

FIG. 2 depicts an introductory user interface for an infinite scroll chat interface of the embodiment of FIG. 1;

FIG. 3 depicts a user interface loaded before an initial chat partner is provided in the infinite scroll chat interface of the embodiment of FIG. 1;

FIG. 4 depicts a chat between the user and a chat partner in the user interface in the infinite scroll chat interface of the embodiment of FIG. 1;

FIG. 5 depicts a transition from the chat partner in FIG. 4 to a new chat partner in the infinite scroll chat interface of the embodiment of FIG. 1;

FIG. 6 depicts a chat between the user and a new chat partner shown in FIG. 6 in the user interface in the infinite scroll chat interface of the embodiment of FIG. 1;

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

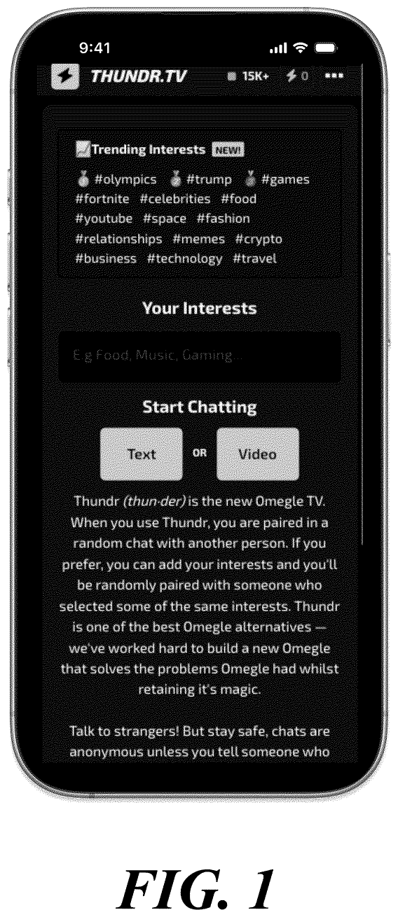

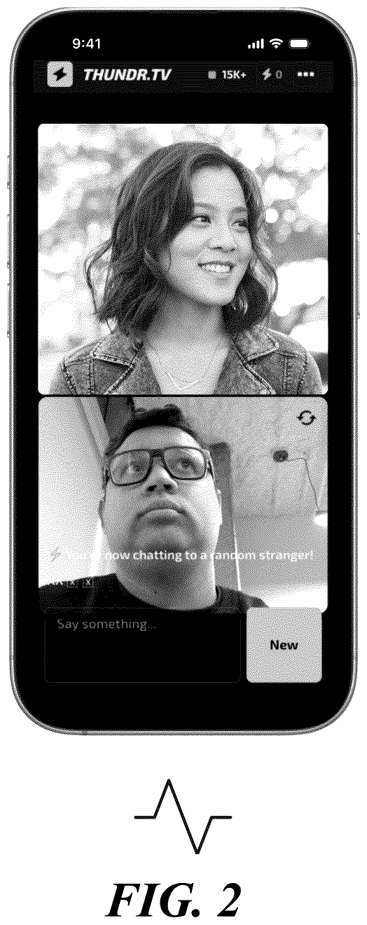

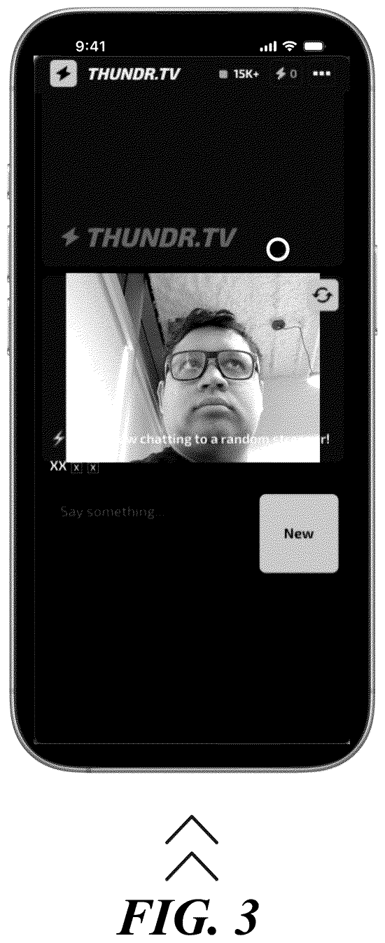

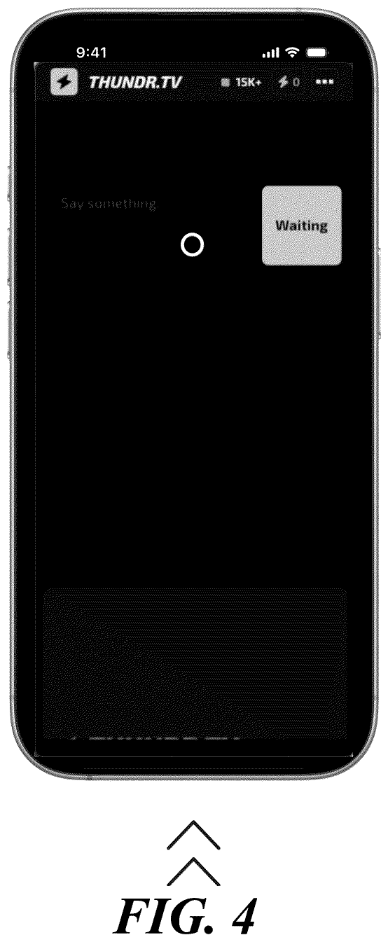

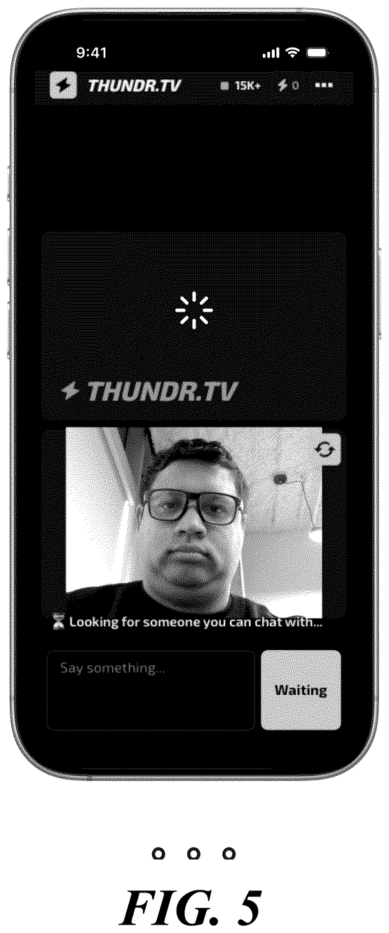

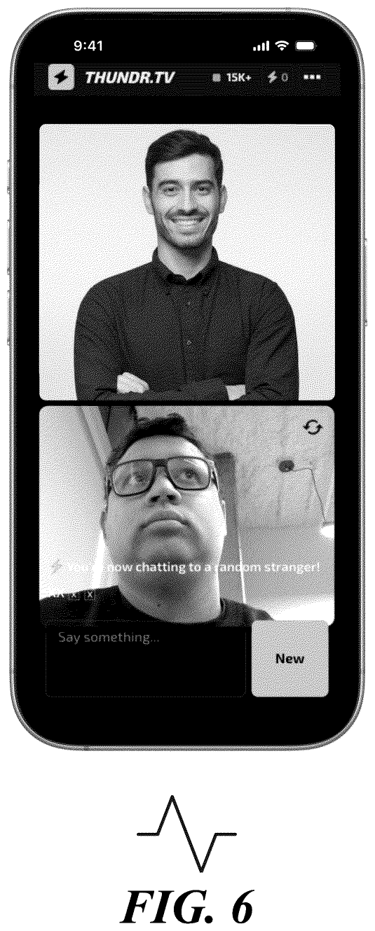

Referring to FIG. 1 through 6, in embodiments, the invention implements an infinite scroll mechanism for video chat that utilizes an adaptive bandwidth management system. This system dynamically adjusts video quality based on the current network conditions to provide a seamless user experience. The adaptive bandwidth management system achieves this by continuously monitoring key network parameters, including latency, jitter, and packet loss. Latency refers to the delay between the transmission and receipt of data, which directly impacts the responsiveness of the video stream. Jitter measures the variability in packet arrival times, and excessive jitter can lead to choppy video playback. Packet loss indicates the proportion of data packets that fail to reach their destination, which can degrade video quality significantly. By analyzing these parameters in real time, the system optimizes the video stream, adjusting resolution, frame rate, and compression levels to maintain smooth playback and reduce buffering or disruptions, even under varying network conditions.

In another embodiment, the invention features a swipe-to-match infinite scroll interface that incorporates a haptic feedback system to enhance user interaction. The haptic feedback system provides tactile responses to users as they scroll through potential matches or engage with the interface, simulating the physical sensation of turning a page. This is accomplished through vibration motors embedded within the user's device, which produce precise vibration patterns corresponding to user actions such as swiping or tapping. The addition of this tactile element fosters a more immersive and intuitive interaction, creating a deeper sense of engagement. By integrating physical sensations into the digital experience, the system enriches user interaction, making the interface more enjoyable and interactive.

In yet another embodiment, a multi-layered security protocol is implemented to ensure the secure transmission of user data over WebSocket connections. WebSockets enable real-time, bidirectional communication between the client and the server, making them essential for video chat applications but also posing potential security risks. The multi-layered security protocol provides customizable encryption settings, allowing users or administrators to choose different levels of encryption complexity based on their preferences or compliance with regulatory requirements. For instance, users may select between encryption standards such as AES-128 or AES-256, balancing security needs with performance requirements. Additionally, the system incorporates a threat detection module within the server backend. This module proactively identifies and mitigates potential security breaches, such as unauthorized access attempts or suspicious traffic patterns, ensuring the integrity and confidentiality of user data throughout the communication process.

Another embodiment involves concurrent backend optimization facilitated by load forecasting algorithms. These algorithms predict peaks in user activity by analyzing historical usage data and current trends. For example, historical data may reveal patterns of increased usage during specific hours or events, while real-time analytics provide insights into ongoing user activity. By forecasting potential surges in demand, the system allocates additional computational resources in advance, such as processing power, memory, and bandwidth. This proactive resource management ensures consistent platform performance, preventing server overload and delivering a smooth user experience even during high-traffic periods.

In an additional embodiment, the invention enhances the user experience during transitions between chat participants by employing an advanced dummy component. This component prefetches user profile metadata, such as interests, mutual connections, or other contextual information, from the upcoming chat participant before the live video feed is fully loaded. The prefetched metadata is displayed within a placeholder element, providing the user with meaningful contextual information during the transition phase. For instance, the placeholder may display a message such as “You and Alex share three mutual interests” or “Alex is interested in hiking and photography.” By presenting this information before the video feed is ready, the system ensures that the transition feels seamless and engaging, creating a richer and more informative experience for the user.

The present invention provides methods involving facilitating real-time online chat interactions between users. The method involves providing an application that allows multiple users to create a user account and interact within the application through a touch screen user interface as a client on a server. The application creates a real-time list of online users by determining which of the multiple users are currently using the application. The application allows a primary user, selected from the list of online users, to live chat with a chat partner, also selected from the list of online users. The chat partner is displayed to the primary user in a chat window in the user interface and the primary user is allowed to select a new chat partner by swiping on the user interface. The application may be an application in a web browser or may be a separate app on a mobile device.

The user as a client interacts with the server through WebSockets. WebSockets are a communication protocol that enables a persistent, full-duplex connection between a client, such as a web browser or an application, and a server. This means that both the client and server can send and receive data at any time without waiting for a request from the other side. Unlike the traditional HTTP protocol, which operates on a request-response basis, WebSockets establish a single connection that remains open for the duration of the interaction, reducing overhead and latency.

The WebSocket process begins with a handshake, where the client sends an initial HTTP request to the server, including a special header signaling the desire to switch to the WebSocket protocol. If the server agrees, it responds with a status code indicating that the connection is being upgraded, and the communication shifts to the WebSocket protocol. Once established, this connection allows continuous, real-time data exchange without the need to repeatedly establish new connections.

WebSockets are particularly efficient because, after the initial handshake, data is transferred as lightweight frames over the same connection. This persistent link reduces the time and resources required for communication compared to repeatedly opening and closing connections, as is common with HTTP.

The method further includes adjusting the video quality of the primary user and the chat partner using an adaptive bandwidth management system. This system dynamically adjusts the video quality based on the available bandwidth, ensuring a smooth and uninterrupted chat experience. An adaptive bandwidth management system is a dynamic mechanism designed to optimize the quality and efficiency of data transmission over a network by adjusting the bandwidth allocation and data flow based on real-time network conditions. This system operates by continuously monitoring key parameters of the network, such as latency, jitter, packet loss, and available bandwidth, and using these metrics to make intelligent adjustments to the data being transmitted.

In one embodiment, the adaptive bandwidth management system is integrated into a video streaming application to ensure the seamless delivery of video content. The system evaluates network conditions in real-time, identifying changes in performance that could impact the user experience. For instance, if an increase in latency or packet loss is detected, the system dynamically reduces the resolution or frame rate of the video stream to prevent buffering or interruptions. Conversely, when favorable network conditions are restored, the system automatically increases the video quality to enhance the user's experience.

The system achieves these optimizations by employing algorithms that predict and respond to network fluctuations. For example, it may use predictive models based on historical data to anticipate bandwidth availability or rely on real-time feedback loops to adjust parameters such as compression ratios and encoding bitrates. These adjustments are made with minimal latency, ensuring that users experience smooth and uninterrupted service.

In addition to optimizing video quality, the adaptive bandwidth management system can also prioritize specific data types or services depending on the application. For instance, in a video chat application, the system may allocate more bandwidth to audio data during periods of congestion, as audio is typically more critical for communication than video. This prioritization ensures that the essential aspects of the service remain functional even under constrained network conditions.

The adaptive bandwidth management system may also feature multi-channel monitoring capabilities, enabling it to manage bandwidth across multiple devices or users simultaneously. In such embodiments, the system can allocate bandwidth dynamically between users based on their real-time requirements, ensuring equitable distribution of resources and preventing any single user from monopolizing the network.

The application may also provide a tactile response when the user takes an action through the user interface. This tactile feedback enhances the user experience by providing a physical response to user actions. The method further includes implementing a multi-layered security protocol to ensure the safe transmission of user data during a video chat. This security protocol protects user data from unauthorized access and potential cyber threats.

The method further includes creating a dummy version of the new chat partner and presenting the dummy version to the primary user before the live chat is established with the new chat partner. A dummy version of a user interface functions as a temporary placeholder that is displayed while the actual content is being retrieved or processed. This dummy interface ensures a smooth and seamless transition between posts by preventing interruptions caused by blank screens or noticeable loading delays.

The dummy interface is designed to provide a visual representation of the forthcoming content, maintaining the structural and stylistic consistency of the application's actual user interface. For example, the dummy version may include placeholder elements such as grayed-out boxes for text, generic or blurred images for visual content, and animated indicators to signal that the new post is being prepared. These elements mimic the layout and appearance of the real content, ensuring that the visual flow remains uninterrupted.

The dummy interface is also designed to support user interactions, allowing users to continue swiping or navigating through the application without waiting for the actual content to load. This ensures that the application's core functionality remains operational, even in scenarios where network conditions may delay content retrieval.

The transition between the dummy interface and the fully loaded content is executed seamlessly, often employing smooth animations or updates to replace the placeholder elements with the actual video feed. This integration reinforces the application's polished and professional appearance, fostering user satisfaction and engagement.

By implementing a dummy version of the user interface, the application effectively bridges the gap between content transitions, maintaining visual continuity and delivering a user experience that feels fluid and responsive. This approach not only minimizes user frustration but also sustains the dynamic flow that is central to swipe-based navigation in modern mobile applications. The dummy version may be optimized to reduce perceived latency for the primary user, providing a seamless chat experience.

The processor operates in conjunction with machine learning models to predict user interaction patterns and optimize resource allocation. This allows the system to learn from user behavior and make intelligent decisions to improve the overall user experience.

The present invention also provides a system involving facilitating instantaneous video chats includes a user interface configured to simulate infinite scrolling between video chat participants by dynamically loading new participants in real-time. A dummy component is instantiated initially as a placeholder without a live video feed. The system also includes a WebSocket protocol implementation, and a backend architecture adapted to support high concurrency utilizing load-balancing techniques. The user interface tracks finger movements of the user to provide fluid transitions between video chat participants. The backend architecture includes an Elixir programming framework to optimize real-time video chat functionality. The dummy component creates a continuous interface illusion during the transition to a live participant, maintaining a seamless user experience.

These embodiments collectively demonstrate the invention's ability to optimize video chat functionality, enhance user interaction, maintain robust security, and deliver seamless transitions, thereby providing a superior overall experience in video communication platforms.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A method of providing an online chat interface comprising the acts of:
providing an application that allows a plurality of users to create a user account and interact in the application through a touch screen user interface as a client on a server;
creating a real time list of online users by determining which of the plurality of users are currently using the application;
allowing a primary user selected from the list of online users to live chat with a chat partner selected from the list of online users and displaying the chat partner to the primary user in a chat window in the user interface;
configuring the user interface to allow the primary user to select a new chat partner by swiping on the user interface.

2. The method of claim 1, wherein the client interacts with the server through WebSockets.

3. The method of claim 1 further comprising adjusting video quality of the primary user and the chat partner using an adaptive bandwidth management system.

4. The method of claim 1 further comprising providing a tactile response when the user takes an action through the user interface.

5. The method of claim 2 further comprising implementing a multi-layered security protocol to ensure the safe transmission of user data during a video chat.

6. The method of claim 1 further comprising running a load forecasting algorithm to predict peaks in user activity.

7. The method of claim 1 further comprising creating a dummy version of the new chat partner and presenting the dummy version to the primary user before the live chat is established with the new chat partner.

8. The method of claim 7 wherein the dummy version is optimized reduce perceived latency for the primary user.

9. The method of claim 1 wherein the dummy version is a chat window without the new chat partner displayed in the chat window.

10. The method of claim 1 wherein the processor operates in conjunction with machine learning models to predict user interaction patterns and optimize resource allocation.

11. A system for facilitating instantaneous video chats between a user and a chat partner, the system comprising:
a user interface configured to simulate infinite scrolling between video chat participants by dynamically loading new participants in real-time;
a dummy component instantiated initially as a placeholder without a live video feed;
a WebSocket protocol implementation to establish a full-duplex, persistent connection between a client and a server for real-time data exchange;
backend architecture adapted to support high concurrency utilizing load-balancing techniques
a user interface that tracks finger movements of the user to provide fluid transitions between video chat participants.

12. The system of claim 11 wherein the backend architecture includes an Elixir programming framework to optimize real-time video chat functionality.

13. The system of claim 11, wherein the dummy component creates a continuous interface illusion during the transition to a live participant.

14. A method for enabling spontaneous video chat sessions between a user and a chat partner, the method comprising the acts of:
dynamically loading data for the user in a user interface simulating infinite scrolling;
utilizing a dummy component as an initial placeholder in the absence of a live video feed;
establishing a WebSocket connection for persistent, real-time data exchange;
handling concurrent connections through a backend system with load-balancing capabilities.

15. The method of claim 14, wherein the backend system employs Elixir programming to facilitate high-concurrency video chat sessions.

16. The method of claim 14, wherein the dummy component is utilized to maintain a continuous user interface experience during loading of live video feeds.
